(19) United States
(12) Patent Application Publication
(10) Pub. No.: US 2005/0223585 A1
(43) Pub. Date: Oct. 13, 2005

(54) Clothes dryer

(75) Inventors: Si-Moon Jeon, Seoul (KR); Kyung-Seop Hong, Incheon (KR)

Correspondence Address: GREENBLUM & BERNSTEIN, P.L.C., 1950 ROLAND CLARKE PLACE, RESTON, VA, 20191, US

(73) Assignee: LG Electronics Inc., Seoul (KR)

(21) Appl. No.: 10/957,601

(22) Filed: Oct. 5, 2004

(30) Foreign Application Priority Data
Apr. 7, 2004 (KR) 23840/2004

(51) Int. Cl. F26B 21/06; F26B 19/00

(52) U.S. Cl. 34/82; 34/202

(57) ABSTRACT

A clothes dryer comprises a cabinet, a drum rotatably installed within the cabinet and accommodating clothes to be dried therein, a drum rotation device for rotating the drum, an air circulation device installed in the cabinet, for sucking external air and thereby introducing into the drum, and discharging air that has passed through the drum to outside of the cabinet, a heater for heating air being introduced into the drum, and a filtering device for filtering external air being introduced into the cabinet. According to this, foreign materials included in suction air introduced into the clothes dryer are filtered, thereby preventing clothes inside the drum from being polluted and preventing components inside the clothes dryer from being damaged.

### BACKGROUND OF THE INVENTION

1. Field of the Invention

The present invention relates to a clothes dryer, and more particularly, to a clothes dryer having a filtering device for filtering sucked air.

2. Description of the Conventional Art

Generally, a clothes dryer is separately installed from a washing machine thereby to automatically dry wet clothes that has completed a washing operation. According to a drying method, the clothes dryer can be divided into a condensation type and an exhaust type.

The condensation type clothes dryer is provided with a heat exchanger for condensing moisture included in air that has passed through a drum therein. The condensation type clothes dryer circulates air therein thus to discharge condensed water outwardly, and heats dry air by a heater thus to supply into the drum, thereby drying clothes inside the drum.

The exhaust type clothes dryer sucks external air, heats the sucked air by a heater thus to introduce into a drum, and discharges air that has passed through the drum outwardly, thereby drying clothes inside the drum.

As shown in FIG. 1, the conventional exhaust type clothes dryer comprises: a cabinet 10 having an inlet 10a for introducing clothes and a door 11 for opening and closing the inlet 10a at a front side thereof; a drum 12 rotatably installed in the cabinet 10 and for accommodating clothes; a drum rotation device 14 for rotating the drum 12; an air circulation device 15 for sucking external air into the cabinet 10 and thereby introducing into the drum 12, and discharging air that has passed through the drum 12 outwardly; and a heater 16 for heating air introduced into the drum 12.

The drum rotation device 14 includes: a driving motor 13 arranged at one side of the drum 12 and generating a rotational force; a pulley 14a installed at a rotational shaft of the driving motor 13; and a belt 14b installed to cover outer circumferences of the drum 12 and the pulley 14a, for transmitting a rotational force of the driving motor 13 to the drum 12.

The air circulation device 15 includes: a suction port 15a formed at a rear upper wall of the cabinet 10, for sucking external air into the cabinet 10; a suction duct 15b respectively connected to inside of the cabinet 10 and an opening portion 12b formed at a rear side of the drum 12, for introducing air that has been sucked into the cabinet 10 into the drum 12; a fan 15c installed at the suction duct 15b and connected to the driving motor 13 thus to be rotated, for sucking external air and thereby introducing into the drum 12; and an exhaust duct 15d connected to an opening portion 12a formed at a front side of the drum 12, for discharging air that has passed through the drum 12 to outside of the cabinet 10.

The heater 16 is installed in the suction duct 15b thereby to heat air introduced into the drum 12 through the suction duct 15b.

In the conventional clothes dryer, when the driving motor 13 and the heater 16 are operated, the drum 12 connected to the driving motor 13, the pulley 14a, and the belt 14b is rotated thus to stir clothes accommodated in the drum 12. As the driving motor 13 is operated, the fan 15c is operated and thereby external air is sucked into the cabinet 10 through the suction port 15a. The sucked air is introduced into the suction duct 15b, and is heated by the heater 16 thus to be introduced into the drum 12.

The air of high temperature that has been introduced into the drum 12 deprives moisture of the clothes inside the drum 12, and the air including the moisture is discharged outwardly through the exhaust duct 15d. By said process, the wet clothes inside the drum 12 are dried.

However, in the conventional clothes dryer, a filtering device for filtering air sucked through the suction port 15a formed at the rear upper wall of the cabinet 10 is not provided, so that foreign materials such as dust, bug, etc. are introduced into the cabinet 10 and the drum 12 by an air flow. According to this, clothes to be dried are polluted, and components such as the driving motor 13, the fan 15, the heater 16, etc. are damaged.

### SUMMARY OF THE INVENTION

Therefore, an object of the present invention is to provide a clothes dryer capable of preventing a clothes pollution and a component damage due to an introduction of foreign materials by installing a filtering device for filtering external air sucked into the clothes dryer.

To achieve these and other advantages and in accordance with the purpose of the present invention, as embodied and broadly described herein, there is provided a clothes dryer comprising: a cabinet; a drum rotatably installed within the cabinet and accommodating clothes to be dried therein; a drum rotation device for rotating the drum; an air circulation device installed in the cabinet, for sucking external air and thereby introducing into the drum, and discharging air that has passed through the drum to outside of the cabinet; a heater for heating air being introduced into the drum; and a filtering device for filtering external air being introduced into the cabinet.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a sectional view showing a clothes dryer in accordance with the conventional art;

FIG. 2 is a sectional view showing a clothes dryer according to the present invention;

FIG. 3 is an exploded perspective view showing a filtering device provided at the clothes dryer according to the present invention;

FIG. 4 is a sectional view showing the filtering device provided at the clothes dryer according to the present invention;

FIG. 5 is an exploded perspective view showing a filtering device provided at the clothes dryer according to another embodiment of the present invention; and

FIG. 6 is an enlargement sectional view of a main part of FIG. 5.

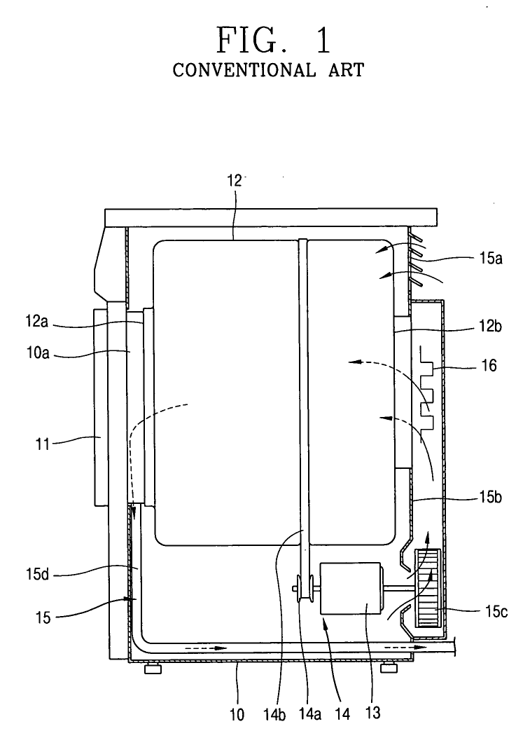

### DETAILED DESCRIPTION OF THE PREFERRED EMBODIMENTS

Reference will now be made in detail to the preferred embodiments of the present invention, examples of which are illustrated in the accompanying drawings.

Hereinafter, a preferred embodiment of the present invention will be explained with reference to the attached drawings.

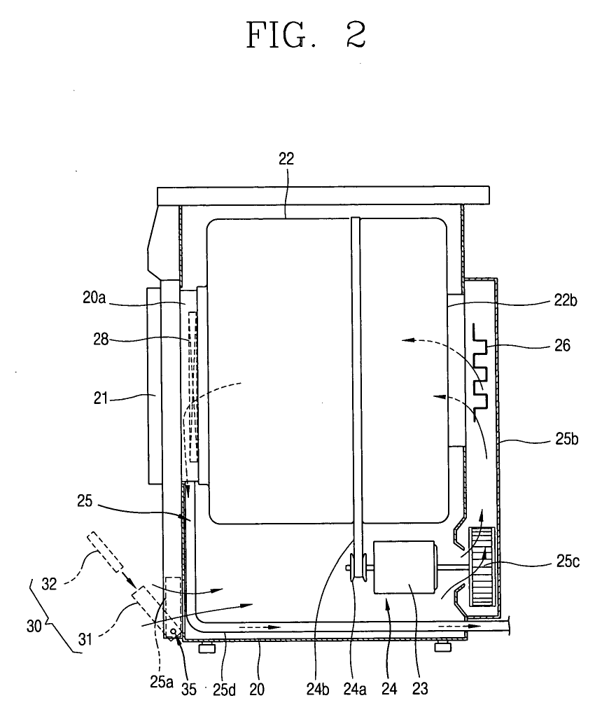

As shown in FIG. 2, the clothes dryer according to the present invention comprises: a cabinet 20 having an inlet 20a for introducing clothes and a door 21 for opening and closing the inlet 20a at a front side thereof; a drum 22 rotatably installed in the cabinet 20 and for accommodating clothes to be dried; a drum rotation device 24 for rotating the drum; an air circulation device 25 for sucking external air into the cabinet 20 thereby circulating into the drum 22, and discharging air that has passed through the drum 22 outwardly; a heater 26 for heating air introduced into the drum 22; and a filtering device 30 for filtering external air introduced into the cabinet 20 by the air circulation device 25.

The drum rotation device 24 includes: a driving motor 23 arranged at one side of the drum 22 and generating a rotational force; a pulley 24a installed at a rotational shaft of the driving motor 23; and a belt 24b installed to cover outer circumferences of the drum 22 and the pulley 24a, for transmitting a rotational force of the driving motor 23 to the drum 22.

The air circulation device 25 includes: a suction port 25a formed at one side of the door 21 of the cabinet 20, for sucking external air into the cabinet 20; a suction duct 25b respectively connected to inside of the cabinet 20 and an opening portion 22b formed at a rear side of the drum 22, for introducing air that has been sucked into the cabinet 20 into the drum 22; a fan 25c installed at the suction duct 25b and connected to the driving motor 23 thus to be rotated, for sucking external air and thereby introducing into the drum 22; an exhaust duct 25d connected to an opening portion 22a formed at a front side of the drum 22, for discharging air that has passed through the drum 22 to outside of the cabinet 20; and a filer 28 detachably installed at the opening portion 22a of the drum 22, for filtering air discharged from the drum 22.

The heater 26 is installed in the suction duct 25b thereby to heat air introduced into the drum 22 through the suction duct 25b.

The filter 28 is formed as a porous shape, and filters foreign materials such as thread included in the air discharged from the drum 22, etc. thus to prevent the exhaust duct 25d from being blocked.

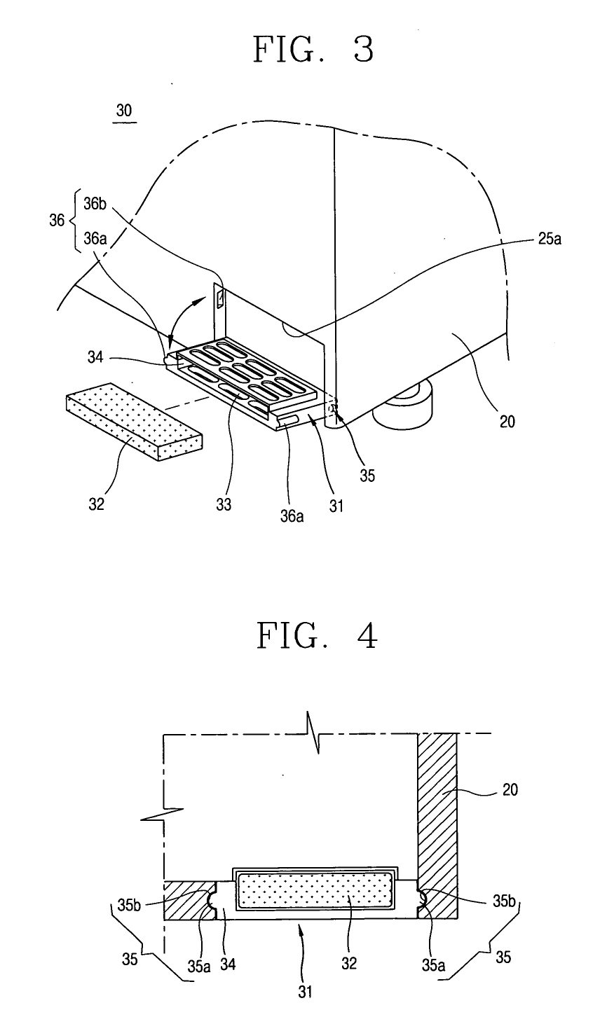

As shown in FIGS. 3 and 4, the filtering device 30 includes: a grill member 31 hingedly coupled to the suction port 25a, for opening and closing the suction port 25a; and a filter 32 of a porous shape detachably mounted at the grill member 31.

The grill member 31 is composed of: a filter accommodation portion 34 having at least one through hole 33 for passing air at both sides thereof and having a space for interposing the filter 32 therein; a hinge connection portion 35 for hingedly coupling the filter accommodation portion 34 to inside of the suction port 25a; and a fixing portion 36 for fixing the filter accommodation portion 34 to inside of the suction port 25a.

The hinge connection portion 35 is composed of: hinge grooves 35b extended from both sides of the filter accommodation portion 34 and concaved at an inner side of the suction port 25a; and a pair of hinge shafts 35a inserted into the hinge grooves 35b. The hinge connection portion 35 is not limited to said structure. The hinge groove can be formed at both sides of the filter accommodation portion 34, and the hinge shaft can be formed at the inner side of the suction port 25a.

The fixing portion 36 is composed of: a fixation groove 36b extended at one side of the filter accommodation portion 34 and concaved at an inner side of the suction port 25a; and a fixation protrusion 36a inserted into the fixation groove 36b. The fixing portion 36 is not limited to said structure. The fixation groove can be formed at one side of the filter accommodation portion 34, and the fixation protrusion can be formed at the inner side of the suction port 25a.

Under said construction, when the filter 32 is to be mounted/detached at/from the grill member 31, a user pulls the grill member 31. According to this, the grill member 31 is rotated centering around the hinge shaft 35a, and thereby the suction port 25a and the filter accommodation portion 34 are opened outwardly. Also, when the filter 32 is to be inserted/detached into/from the filter accommodation portion 34, the user pushes the grill member 31. According to this, the grill member 31 is rotated centering around the hinge shaft 35a, and the fixation protrusion 36a is inserted into the fixation groove 36b thus to close the suction port 25a, thereby completing the mounting/detaching operation of the filter 32.

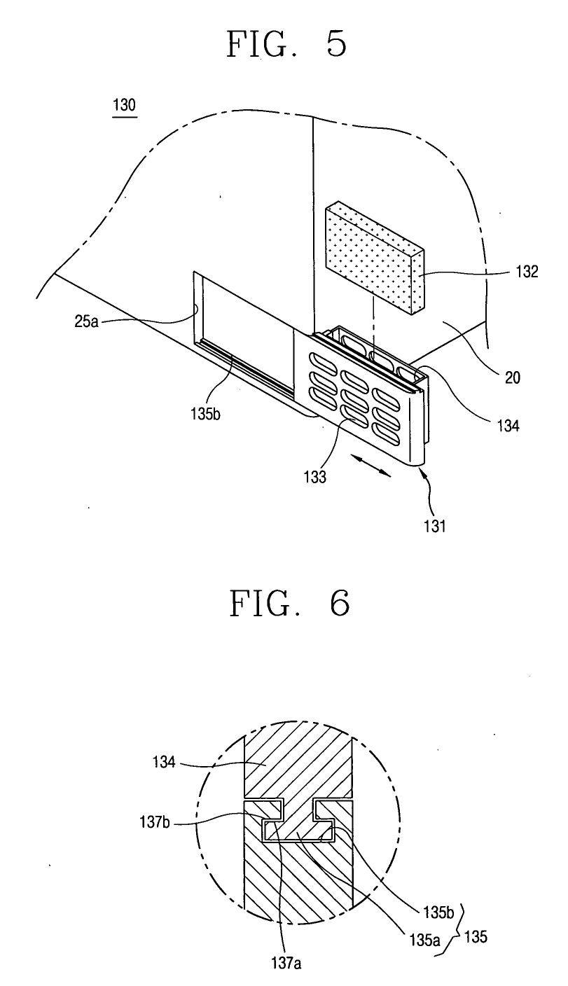

Hereinafter, another embodiment of the filtering device provided at the clothes dryer according to the present invention will be explained with reference to FIGS. 5 and 6. Explanations of the construction of the clothes dryer aforementioned in the first preferred embodiment will be omitted.

A filtering device 130 provided at the clothes dryer according to another embodiment of the present invention is composed of: a grill member 131 slidably installed at the suction port 25a, for opening and closing the suction port 25a while being slid; and a filter 132 detachably mounted at the grill member 131.

The grill member 131 is composed of: a filter accommodation portion 134 having at least one through hole 133 for passing air at both sides thereof and having a space for interposing the filter 132 therein; and a slide portion 135 formed at one side of the filter accommodation portion 134, for slidably installing the grill member 131 at the inner side of the suction port 25a.

The slide portion 135 is composed of: a guide groove 135b concaved at an inner side of the suction port 25a and extended to a slide direction of the grill member 131; and a guide protrusion 135a protruded at one side of the filter accommodation portion 134 and extended to a slide direction of the grill member 131 so as to be inserted into the guide groove 135b. The slide portion is not limited to said construction. The guide groove can be formed at the grill member 131, and the guide protrusion can be formed at the inner side of the suction port 25a.

It is preferable that the guide protrusion 135a and the guide groove 136b are respectively provided with a step 137a and a step 137b that are engaged to each other lest the grill member 131 should be easily detached from the suction port 25a.

Under said construction, when the filter 132 is to be mounted/detached at/from the grill member 131, the user pulls the grill member 131. According to this, while the grill member 131 is slid, the suction port 25a and the filter accommodation portion 134 are opened outwardly. Also, when the filter 132 is to be inserted/detached into/from the filter accommodation portion 134, the user pushes the grill member 131. According to this, while the grill member 131 is slid, the suction port 25a is closed and the mounting/detaching operation of the filter 132 is completed.

In the clothes dryer according to the present invention, foreign materials such as dust, bug, etc. are filtered from suction air sucked into the cabinet 20. According to this, a clothes pollution and a component damage due to an introduction of foreign materials can be prevented.

Also, since the grill members 31 and 131 of the filtering devices 30 and 130 are detachably installed at the suction port 25a as a rotary type or a slide type, the mounting/detaching operation of the filters 32 and 132 can be easily performed.

Additionally, since the suction port 25a is formed at the front side of the cabinet 10 where the door 21 is installed, the user can easily exchange the filter 32.

Also, since the filter 28 for filtering foreign materials included in air discharged from the drum 22 is installed at one side of the drum 22, the exhaust duct 25d is prevented from being blocked.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

1. A clothes dryer, comprising:
a cabinet;
a drum rotatably installed within the cabinet that accommodates clothes to be dried therein;
a drum rotation device that rotates the drum;
a suction port, formed at one side of a front surface of the cabinet to suck external air into the cabinet, the front surface including a door to selectively open and close the drum;
a suction duct formed in the cabinet that connects to an opening portion at a rear side of the drum to introduce air that has been sucked into the cabinet into the drum;
a fan connected to a driving motor of the drum rotation device to suck external air into the cabinet through the suction port and introduce the air into the drum through the suction duct;
an exhaust duct connected to an opening Portion formed at a front side of the drum to discharge air that has passed through the drum to outside the cabinet;
a heater, associated with the suction duct, that heats air introduced into the drum; and
a filtering device, provided at the suction port, that prevents foreign materials included in external air from reaching the driving motor, the filtering device comprising a grill member, hingably attached to the suction port, to selectively open and close the suction port, and a filter removably Provided with the grill member.

2. (canceled)

3. (canceled)

4. The clothes dryer of claim 1, wherein the grill member comprises:
a filter accommodation portion configured to hold the filter, and having at least an aperture to allow a passage of air through the filter accommodation portion;
a hinge that connects the filter accommodation portion to the suction port; and
a fixing portion that fixes the filter accommodation portion to the suction port.

5. The clothes dryer of claim 4, wherein the hinge includes a hinge shaft extended on both sides of the filter accommodation portion so as to be inserted into hinge grooves formed in the suction port.

6. The clothes dryer of claim 4, wherein the fixing portion includes a fixation protrusion extended on one side of the filter accommodation portion so as to be inserted into a fixation groove formed in the suction port.

7. The clothes dryer of claim 1, wherein the filtering device comprises:
a grill member slidably installed at the suction port, for opening and closing the suction port while being slid; and
a filter detachably mounted at the grill member.

8. The clothes dryer of claim 7, wherein the grill member comprises:
a filter accommodation portion having at least one through hole for passing air at both sides thereof and having a space for interposing the filter therein; and
a slide portion formed at one side of the filter accommodation portion, for slidably installing the grill member at the inner side of the suction port.

9. The clothes dryer of claim 8, wherein the slide portion includes a guide protrusion protruded at one side of the filter accommodation portion, extended in a direction that the grill member slides and inserted into a guide groove recessed in the suction port and extended in a direction that the grill member slides.

10. The clothes dryer of claim 9, wherein the guide protrusion and the guide groove are provided with steps engaged to each other.

11. (canceled)

12. (canceled)

13. The clothes dryer of claim 1, wherein the filtering device is formed so that it does not protrude from the front surface of the cabinet.

14. A clothes dryer, comprising:
a cabinet;
a drum installed within the cabinet;
a drum rotation device that rotates the drum;
a suction port provided at a side of the cabinet;
a suction duct, provided at a rear side of the cabinet between the drum rotation device and a rear side of the drum;
a fan connected to the drum rotation device that sucks external air through the suction port and into the drum via the suction duct;
an exhaust duct connected to an opening in the rear side of the cabinet;
a filtering device, associated with the suction port, that filters the external air sucked through the suction port; and
a first filter, provided at a side of the drum, that filters air provided to the exhaust duct.

15. The clothes dryer of claim 14, further comprising a heater that heats said external air sucked through said suction duct.

16. The clothes dryer of claim 14, wherein said filtering device comprises a filter accommodation portion hingably attached to said suction port, and a second filter removably provided in the filter accommodation portion.

17. The clothes dryer of claim 14, wherein said filtering device comprises a filter accommodation portion slidably attached to said suction port, and a second filter removably provided in the filter accommodation portion.
